(19) United States
(12) Patent Application Publication
(10) Pub. No.: US 2024/0426973 A1
(43) Pub. Date: Dec. 26, 2024

(54) HIGH FREQUENCY SYSTEM

(71) Applicant: TAIYO YUDEN CO., LTD., Tokyo (JP)

(72) Inventor: Hiroyuki KAMO, Tokyo (JP)

(73) Assignee: TAIYO YUDEN CO., LTD., Tokyo (JP)

(21) Appl. No.: 18/829,815

(22) Filed: Sep. 10, 2024

Related U.S. Application Data
(63) Continuation of application No. PCT/JP2023/011816, filed on Mar. 24, 2023.

(30) Foreign Application Priority Data
Mar. 31, 2022 (JP) 2022-060246

(51) Int. Cl. G01S 7/03; G01S 13/32; G01S 13/46; G01S 13/48

(52) U.S. Cl. CPC G01S 7/03; G01S 13/32; G01S 13/48; G01S 2013/462

(57) ABSTRACT

A high frequency system includes an antenna that transmits a high frequency electromagnetic wave vertically polarized with respect to a floor to an object and receives the electromagnetic wave reflected by the object, and a first dielectric layer provided on an uppermost layer of the floor in a region including a portion where the electromagnetic wave is reflected in a path of the electromagnetic wave between the antenna and the object, the first dielectric layer having a relative dielectric constant of 2 or more and 6 or less at a frequency of the electromagnetic wave, wherein the electromagnetic wave propagating through the first dielectric layer is reflected under the first dielectric layer, and a distance between the antenna and the object in a direction parallel to a plane including an upper surface of the first dielectric layer at the portion is 10 m or less.

### CROSS-REFERENCE TO RELATED APPLICATION

This application is a continuation application of International Application No. PCT/JP2023/011816 filed on Mar. 24, 2023, which claims priority to Japanese Patent Application No. 2022-060246 filed on Mar. 31, 2022, the entire contents of which are incorporated herein by reference.

### FIELD

A certain aspect of the present disclosure relates to a high frequency system.

### BACKGROUND

There is known a high frequency system for detecting a dangerous material body held by a person or a fall of a person at a short distance as a high frequency system using a high frequency wave such as a millimeter wave (for example, Patent Document 1: Japanese Laid-Open Patent Publication No. 2018-146257, and Patent Document 2: Japanese Laid-Open Patent Publication No. 2020-71226). It is known to provide a radio wave absorber on a floor or the like in order to suppress reflection of a millimeter wave (for example, Patent Document 3: Japanese Laid-Open Patent Publication No. 2003-156570). It is known that a vertically polarized electromagnetic wave incident at a Brewster angle is less reflected than a horizontally polarized electromagnetic wave (for example, Patent Document 4: Japanese Laid-Open Patent Publication No. 2000-28714, and Patent Document 5: Japanese Laid-Open Patent Publication No. 2020-128919). It is known to use a laminated film for preventing reflection of radio waves (for example, Patent Document 6: Japanese Laid-Open Patent Publication No. 2021-162483).

### SUMMARY

In the high frequency system, a high frequency electromagnetic wave is irradiated from a transmitting antenna to an object, and the electromagnetic wave reflected by the object is received by a reception antenna. The paths of the transmission wave radiated from the transmitting antenna to the object include a direct path to reach the object directly and an indirect path to reach the object by reflecting the floor, ceiling, or the like. In the object, the direct wave propagated through the direct path and the indirect wave propagated through the indirect path are combined. The paths along which the reflected wave reflected from the object reaches the receiving antenna also include a direct path and an indirect path. In the receiving antenna, the direct wave propagated through the direct path and the indirect wave propagated through the indirect path are combined. In this way, by combining the two times, the reception power periodically varies depending on the phase and amplitude (spatial attenuation and loss at the time of reflection) of the electromagnetic wave propagated through each path.

The present disclosure has been made in view of the above problems, and an object thereof is to suppress the influence of the indirect wave.

In one aspect of the present disclosure, there is provided a high frequency system including: an antenna that transmits a high frequency electromagnetic wave vertically polarized with respect to a floor to an object and receives the electromagnetic wave reflected by the object; and a first dielectric layer provided on an uppermost layer of the floor in a region including a portion where the electromagnetic wave is reflected in a path of the electromagnetic wave between the antenna and the object, the first dielectric layer having a relative dielectric constant of 2 or more and 6 or less at a frequency of the electromagnetic wave; wherein the electromagnetic wave propagating through the first dielectric layer is reflected under the first dielectric layer, and a distance between the antenna and the object in a direction parallel to a plane including an upper surface of the first dielectric layer at the portion is 10 m or less. In the above configuration, the electromagnetic wave may be a millimeter wave.

In the above structure, an incident angle of the electromagnetic wave incident on the first dielectric layer at the portion may be 30° or more and 70° or less.

In the above configuration, 0.35≤(h1+h2)/R≤1.73 may be satisfied, where h1 is a distance between the antenna and a plane including an upper surface of the first dielectric layer at the portion, h2 is a distance between the plane and the object, and R is a distance between the antenna and the object in a direction parallel to the plane.

In the above configuration, 0.087≤T1×√εᵣ×tan δ×f/c may be satisfied, where T1 [mm] is a thickness of the first dielectric layer, εᵣ is a relative dielectric constant of the first dielectric layer at the frequency of the electromagnetic wave, tan δ is a dielectric loss tangent of the first dielectric layer at the frequency of the electromagnetic wave, f[Hz] is a frequency of the electromagnetic wave, and c [mm/s] is a speed of light in vacuum.

In the above configuration, the frequency of the electromagnetic wave may be 60 GHz or more and 90 GHz or less.

In the above configuration, the frequency of the electromagnetic wave may be 60 GHz or more and 90 GHz or less, and 0.087≤T1× √εᵣ×tan δ×f/c may be satisfied, where T1 [mm] is a thickness of the first dielectric layer, εᵣ is a relative dielectric constant of the first dielectric layer at the frequency of the electromagnetic wave, tan δ is a dielectric loss tangent of the first dielectric layer at the frequency of the electromagnetic wave, f[Hz] is a frequency of the electromagnetic wave, and c [mm/s] is a speed of light in vacuum.

In the above configuration, the high frequency system further may include a second dielectric layer provided between the first dielectric layer and a surface under the first dielectric layer, on which the electromagnetic wave propagating through the first dielectric layer is reflected, the second dielectric layer having a relative dielectric constant at the frequency of the electromagnetic wave higher than the relative dielectric constant of the first dielectric layer at the frequency of the electromagnetic wave.

In the above configuration, a dielectric loss tangent of the second dielectric layer at the frequency of the electromagnetic wave may be greater than a dielectric loss tangent of the first dielectric layer at the frequency of the electromagnetic wave.

In the above configuration, the object may be a person or a material body held by a person.

### BRIEF DESCRIPTION OF THE DRAWINGS

FIG. 1 is a schematic diagram of a millimeter wave system according to a first embodiment;

FIG. 2 is a block diagram of a detector in the first embodiment;

FIG. 3 is a diagram illustrating a propagation model of the millimeter wave system in the first embodiment;

FIG. 4 is a graph illustrating a power loss with respect to a distance R in a first comparative example;

FIGS. 5A to 5C are enlarged cross-sectional views of the vicinity of a floor surface in the first embodiment;

FIG. 6 is a graph illustrating reflection coefficients with respect to an incident angle θᵢ in a vertically polarized wave TM and a horizontally polarized wave TE;

FIG. 7 is a graph illustrating a power loss with respect to the distance R in the vertically polarized wave;

FIG. 8 is a graph illustrating a power loss with respect to the distance R in the horizontally polarized wave; and

FIG. 9 is an enlarged cross-sectional view of the vicinity of a floor surface in a second embodiment.

### DETAILED DESCRIPTION

Hereinafter, an embodiment of the present disclosure will be described with reference to the drawings.

In a high frequency system, for example, an electromagnetic wave having a frequency of 300 MHz or more is used. In the following embodiments, the millimeter wave system for a person or a material body held by a person is described as a high frequency system. A millimeter wave is a radio wave whose frequency is 30 GHz or more and 300 GHz or less. The millimeter wave systems for the person or the material body held by the person include systems for detecting dangerous material bodies or dangerous objects held by pedestrians in airports, stations, and the like, in a non-contact manner, systems for detecting vital signals such as human heartbeat in a non-contact manner, systems for detecting the fall of the person or the life and death of the person, and systems for detecting people's flow. The characteristics of such a millimeter wave system are that a distance between the antenna for transmitting and receiving the millimeter wave and the object is as close as 10 m or less, and the height of the object is lower than the height of the person.

### First Embodiment

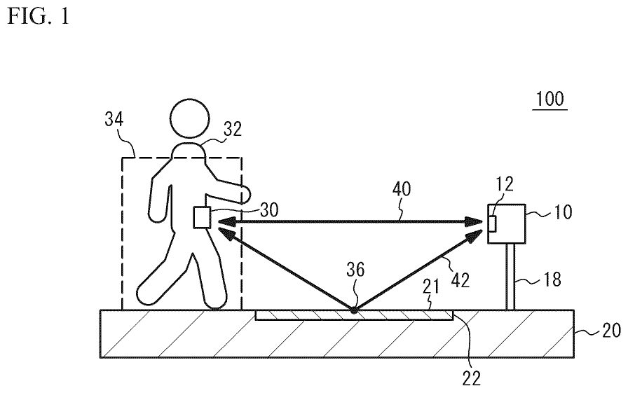

FIG. 1 is a schematic diagram of a millimeter wave system according to a first embodiment. As illustrated in FIG. 1, a detector 10 is mounted on a floor 20 via a support 18. The detector 10 includes an antenna 12. The upper surface of the floor 20 is a floor surface 21. A gate 34 is provided on the floor 20. A millimeter wave system 100 inspects a pedestrian 32 passing through the gate 34. The pedestrian 32 holds an object 30. In the millimeter wave system 100 for detecting a dangerous object, the object 30 is, for example, the dangerous material body held by the pedestrian 32. In the millimeter wave system 100 for detecting vital signals such as heart rate, the object 30 is the chest of the pedestrian 32. The gate 34 may not be provided. A dielectric layer 22 is provided on the floor 20 between the antenna 12 and the object 30.

The antenna 12 irradiates the object 30 with the millimeter wave. The millimeter wave transmitted by the antenna 12 is vertically polarized with respect to the floor surface 21. The antenna 12 receives the millimeter wave reflected by the object 30. There are two millimeter wave paths between the antenna 12 and the object 30. A first path is a path 40 in which the millimeter wave is not reflected by the floor surface 21 and directly propagates between the antenna 12 and the object 30. The millimeter wave propagating through the path 40 is called a direct wave. A second path is a path 42 in which the millimeter wave is reflected by the floor surface 21 and indirectly propagates between the antenna 12 and the object 30. The millimeter wave propagating through the path 42 is called an indirect wave. A portion 36 of the floor surface 21 where the indirect wave is reflected is the upper surface of the dielectric layer 22. The millimeter wave system 100 is installed in a self-contained space where there is almost no reflection of a wall other than a floor surface (for example, a space where reflection of the wall other than the floor surface can be ignored in the operation of the system even in an outdoor or indoor environment).

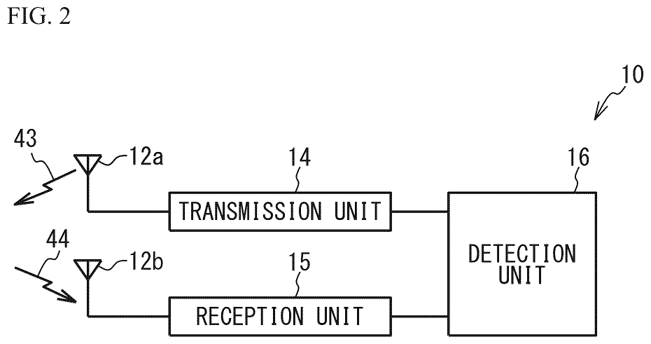

FIG. 2 is a block diagram of a detector according to the first embodiment. As illustrated in FIG. 2, the detector 10 includes antennas 12a, 12b, a transmission unit 14, a reception unit 15, and a detection unit 16. Each of the antennas 12a, 12b may include a plurality of antennas and each of the transmission unit 14, the reception unit 15, and the detection unit 16 may include a plurality of corresponding units. The transmission unit 14 transmits a millimeter wave 43 via the antenna 12a. The reception unit 15 receives a millimeter wave 44 via the antenna 12b. When the plurality of antennas arranged in a direction perpendicular to the floor surface 21 are used as the antennas 12a, the millimeter wave 43 is vertically polarized. When the plurality of antennas arranged in a direction perpendicular to the floor surface 21 are used as the antennas 12b, the vertically polarized millimeter wave 44 can be received. The millimeter wave 43 may be vertically polarized by a method other than the above.

The detection unit 16 detects the object 30 based on the transmitted millimeter wave 43 and the received millimeter wave 44. For example, the detection unit 16 detects whether or not the pedestrian 32 holds the dangerous object, or detects the vital signal of the pedestrian 32. As a method of detecting the position and velocity of the object 30, for example, a method such as an FM-CW (Frequency Modulated Continuous Wave) method, an FCM (Fast-Chirp Modulation) method, or a Doppler method is used.

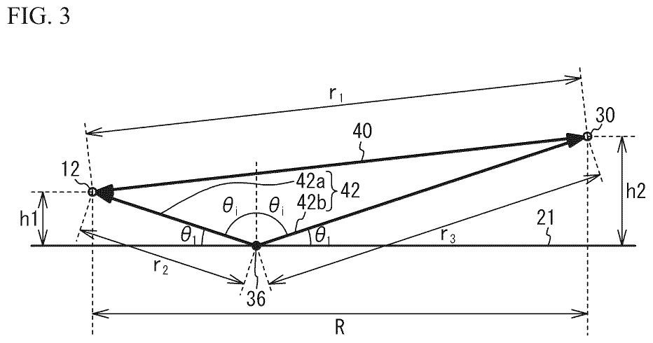

A millimeter wave propagation model of the millimeter wave system according to the first embodiment will be described. FIG. 3 is a diagram illustrating the propagation model of the millimeter wave system 100 in the first embodiment. As illustrated in FIG. 3, the antenna 12 and the object 30 are provided above the floor surface 21. A distance between the antenna 12 and the object 30 in the direction parallel to the floor surface 21 is denoted by R. A distance between the antenna 12 and the object 30 is denoted by r₁. The height of the antenna 12 from the floor surface 21 is referred to as h1, and the height of the object 30 from the floor surface 21 is referred to as h2. The path 40 directly connecting the antenna 12 and the object 30 is a path through which the direct wave propagates. The path 42 reflected on the floor surface 21 between the antenna 12 and the object 30 is a path through which the indirect wave propagates. In the path 42, a path between the antenna 12 and the portion 36 is defined as 42a, and a path between the object 30 and the portion 36 is defined as 42b. The length of the path 42a is r₂, and the length of the path 42b is r₃.

Since the radio wave propagates the shortest distance, an angle θ₁ between the path 42a and the floor surface 21 is equal to an angle θ₁ between the path 42b and the floor surface 21. The incident angle θᵢ of the path 42a (an angle formed by the normal line of the floor surface 21 and the path 42a) is equal to the incident angle θᵢ of the path 42b. The angle θᵢ+θ₁=90° is satisfied. The relationship between the incident angle θᵢ, the heights h1 and h2, and the distance R is expressed by an equation 1.

$$\\ \begin{matrix}tan ( 90 ° - {θ}_{i} ) = \frac{h 1 + h 2}{R} & [ Equation 1 ]\end{matrix}$$

Here, it is assumed that h1=1 m, h2=1.17 m, and R=3.6 m. The height h1 corresponds to the fact that the antenna 12 is provided at a height of 1 m, and h2=1.17 m corresponds to the height from the waist to the chest of a human being. The horizontal distance R is assumed to be a general distance for arranging the antenna 12. In this case, θ₁=tan⁻¹ ((h1+h2)/R)=31°, and θᵢ=59°.

A reception power Pfree of the received millimeter wave in the case where the millimeter wave transmitted from the antenna 12 propagates through the path 40 and is reflected by the object 30, and then propagates through the path 40 and is received by the antenna 12 (that is, in the case of the direct wave) is expressed by an equation 2.

$$\\ \begin{matrix}{P}_{free} = \frac{{P}_{t} {G}_{t} {G}_{r} {λ}^{2} σ}{{( 4 π )}^{3} {r}_{1}^{{}_{} 4}} & [ Equation 2 ]\end{matrix}$$

Here, Pt is a transmission power transmitted by the antenna 12, Gt is a gain of the transmitting antenna 12a, Gr is a gain of the receiving antenna 12b, λ is a wavelength of the millimeter wave in the vacuum, and σ is a reflection cross section of the millimeter wave in the object 30.

When the millimeter wave transmitted from the antenna 12 propagates through the path 40 or 42 and is reflected by the object 30, and then propagates through the path 40 or 42 and is received by the antenna 12 (that is, when both the direct wave and the indirect wave exist), the reception power of the millimeter wave to be received is the product of Pfree of the equation 2 and Er of an equation 3.

$$\\ \begin{matrix}{E}_{r} = [ {e}^{{}_{} - j {β}_{1}} ( 1 + {R}_{1} {D}_{T ( {θ}_{1} )} {e}^{{}_{} - j β ( ( {r}_{2} + {r}_{3} ) - r 1 )} ) ] \times [ {R}_{2} {e}^{{}_{} - j {β}_{1}} ( 1 + {R}_{1} {D}_{R ( {θ}_{1} )} {e}^{{}_{} - j β ( ( {r}_{2} + {r}_{3} ) - r 1 )} ) ] = [ {e}^{{}_{} - j {β}_{1}} ( 1 + {R}_{1} {D}_{T ( {θ}_{1} )} {e}^{{}_{} - j β ( ( {r}_{4} - {r}_{1} ) )} ) ] \times [ {R}_{2} {e}^{{}_{} - j {β}_{1}} ( 1 + {R}_{1} {D}_{R ( {θ}_{1} )} {e}^{{}_{} - j β ( ( {r}_{4} - {r}_{1} ) )} ) ] & [ Equation 3 ]\end{matrix}$$

Here, D_{T}(θ₁) is a directivity of the antenna 12a, D_{R}(θ₁) is a directivity of the antenna 12b, R₁ is a reflection coefficient of the floor surface 21, R₂ is a reflection coefficient of the object 30, and β is a phase coefficient, and r4=r2+r3 is satisfied.

Using the equations 2 and 3, the power loss with respect to the distance is calculated for the direct wave case and for both the direct and indirect wave cases. The calculation conditions are as follows: h1=1 m, h2=1.17 m, Pt=10 dB, Gt=10 dB, Gr=10 dB, and σ=10 dB/m², and the frequency of the millimeter wave is 79 GHz.

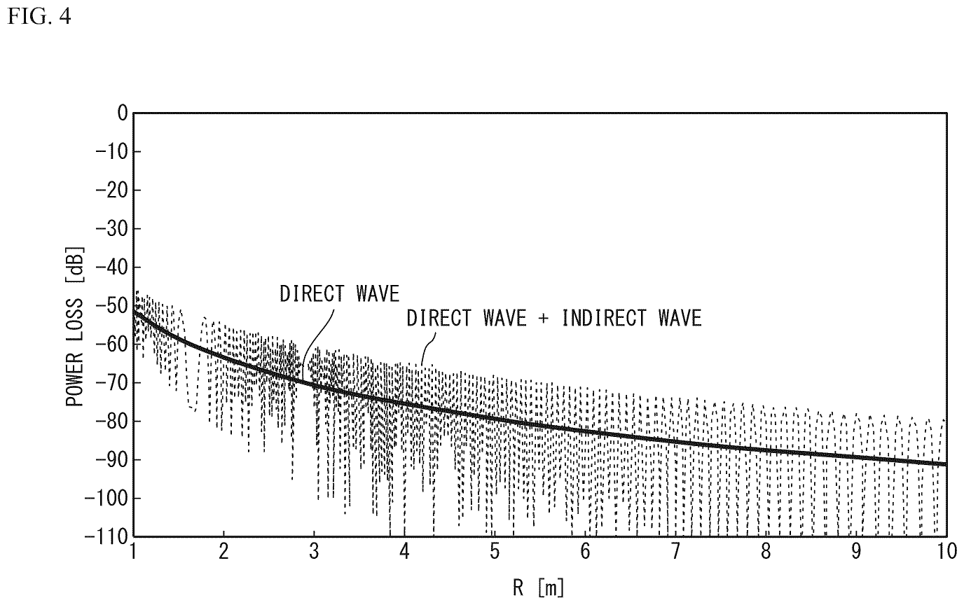

As a first comparative example, the power loss with respect to the distance R was calculated in the case where the floor surface 21 was made of metal. FIG. 4 is a graph illustrating the power loss with respect to the distance R according to the first comparative example. In FIG. 4, a horizontal axis represents the distance R in FIG. 3, and the distance R is varied from 1 m to 10 m. A vertical axis represents the power loss, and the reception power/transmission power is expressed in dB. The power loss of the direct wave is illustrated by a thick solid line, and the power loss of the direct wave and the indirect wave is illustrated by a broken line.

As illustrated in FIG. 4, in the direct wave, the power loss decreases monotonously as the distance R increases. On the other hand, when the direct wave and the indirect wave are combined, the power loss greatly varies with respect to the distance R due to the phase difference between the direct wave and the indirect wave. The distance R between the antenna 12 and the object 30 changes with time. Therefore, when the received wave is affected by the indirect wave, the reception power is not stable.

More specifically, when the received wave is affected by the indirect wave, the reception power becomes a blind spot (reception is disabled) at a frequency where the powers of the direct wave and the indirect wave cancel each other, and the reception level is lowered. The reception power level and the like are locally saturated at the frequency where the powers of the direct wave and the indirect wave are increased. The variation in reception power with frequency or time makes it difficult to stably use the tracking function and estimate the reception level in the millimeter wave system. Since the spatial (element-by-element) or temporal variations in a digital beamforming technique or a Multiple Input and Multiple Output (MIMO) technique increase, the accuracy of the orientation measurement and the orientation resolution are reduced. If the influence of the indirect wave can be reduced, these problems can be solved.

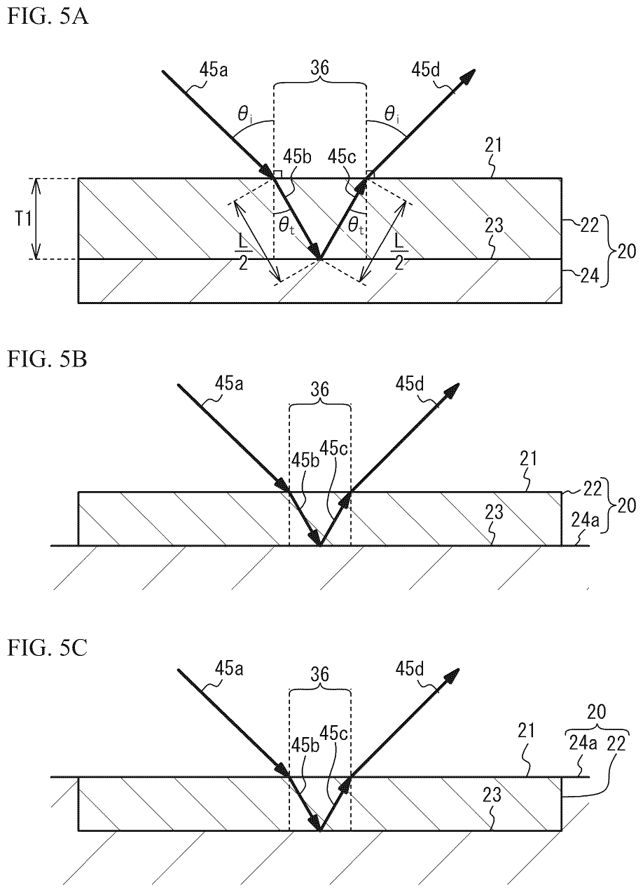

FIGS. 5A to 5C are enlarged cross-sectional views of the vicinity of the floor surface in the first embodiment, and are enlarged views of the vicinity of the portion 36 where the millimeter wave is reflected on the floor surface 21. As illustrated in FIG. 5A, in a region including the portion 36, the floor 20 is provided with the dielectric layer 22 having a thickness of T1 on a reflective layer 24. An interface between the reflective layer 24 and the dielectric layer 22 is a reflective surface 23.

A millimeter wave 45a propagating through the space is incident from the air to the floor surface 21 (the upper surface of the dielectric layer 22) at the incident angle θᵢ. The millimeter wave 45a is refracted at the floor surface 21 and transmitted to the dielectric layer 22 at a transmission angle θₜ. A millimeter wave 45b transmitted into the dielectric layer 22 is reflected by the reflective surface 23. A reflected millimeter wave 45c is refracted at the floor surface 21, and is emitted to the air as a millimeter wave 45d. The incident angle θᵢ of the millimeter wave 45a and the exit angle of the millimeter wave 45d are equal to each other. If the millimeter waves 45b and 45c are attenuated in the dielectric layer 22, the power of the millimeter wave 45d emitted from the dielectric layer 22 becomes smaller than the power of the millimeter wave 45a.

The dielectric layer 22 has a relative dielectric constant of, for example, 2 to 6 and a dielectric loss tangent tan δ of, for example, 0.01 or more. The reflective layer 24 is a metal layer such as a metal panel of aluminum, stainless steel, zinc, or the like. The reflective layer 24 may be a layer made of a material that reflects the millimeter wave, and may be, for example, a material having a large relative dielectric constant.

As illustrated in FIG. 5B, the dielectric layer 22 is provided on the ground or a floor material 24a. The floor material 24a is made of, for example, marble or hard glass. A surface between the dielectric layer 22 and the ground or floor material 24a is the reflective surface 23. The other configuration is the same as that of FIG. 5A. As illustrated in FIG. 5C, the dielectric layer 22 may be embedded in the ground or floor material 24a. The other configuration is the same as that of FIG. 5B. In FIGS. 5B and 5C, the relative dielectric constant of the ground, marble, hard glass, or the like is sufficiently larger than the relative dielectric constant of the dielectric layer 22. Therefore, if the incident angle (corresponding to θₜ) from the dielectric layer 22 to the floor material 24a is large, the millimeter wave is almost reflected on the reflective surface 23. Thus, the floor 20 may include the ground or floor material 24a and the dielectric layer 22.

The relative dielectric constant of the dielectric layer 22 is selected so that the incident angle θᵢ of the millimeter wave 45a becomes the Brewster angle θ_{B}. Assuming that the refractive index of the dielectric layer 22 is n and the refractive index of the space is 1, the Brewster angle θ_{B} is θ_{B}=tan⁻¹(n). A real part of the complex refractive index of the dielectric layer 22 is sufficiently larger than an imaginary part. Therefore, the relationship between the Brewster angle θ_{B} and the relative dielectric constant εᵣ of the dielectric layer 22 is expressed by an equation 4.

$$\\ \begin{matrix}{θ}_{B} = {tan}^{- 1} ( \sqrt{ε r} ) & [ Equation 4 ]\end{matrix}$$

The relationship between the transmission angle θₜ and the incident angle θᵢ is n=sin θi/sin θₜ, where n is the refractive index of the dielectric layer 22. Therefore, the transmission angle θₜ is expressed by an equation 5.

$$\\ \begin{matrix}{θ}_{t} = {sin}^{- 1} ( \frac{sin {θ}_{i}}{\sqrt{ε r}} ) & [ Equation 5 ]\end{matrix}$$

A propagation length L of the millimeter waves 45b and 45c in the dielectric layer 22 is expressed by an equation 6.

$$\\ \begin{matrix}L = \frac{2 \times T 1}{cos {θ}_{t}} & [ Formula 6 ]\end{matrix}$$

In FIG. 5A, a case where the floor surface 21 on which the dielectric layer 22 is provided and the floor surface 21 on which the antenna 12 and the object 30 are provided are the same planes has been described. More generally, h1 is the distance between the antenna 12 and a plane including the floor surface 21 (i.e., the upper surface of the dielectric layer 22) at the portion 36, h2 is the distance between this plane and the object 30, and R is the distance between the antenna 12 and the object 30 in a direction parallel to this plane.

The power loss with respect to the distance R in the first embodiment was calculated. Under the conditions of h1=1 m, h2=1.17 m, and R=3.6 m described in FIG. 3, the incident angle is θᵢ=59°, and the relative dielectric constant εᵣ of the dielectric layer 22 satisfying θ_{B}=θᵢ is εᵣ=(tan θᵢ)²≈2.8 from the equation 4. A material having the relative dielectric constant εᵣ of about 2.8 and a relatively large dielectric loss tangent tan δ (for example, tan δ of 0.01 or more) at a frequency of 79 GHz is, for example, Polypenco acetal which is a resin made of an acetal copolymer as a raw material. Polypenco is a registered trademark. The tan δ of Polypenco acetal at 79 GHz is 0.02.

The dielectric layer 22 was made of Polypenco acetal, and the reflection coefficient at the time of incidence from the air into the dielectric layer 22 was calculated with respect to the incident angle θᵢ. The reflection coefficients were calculated by using the Fresnel equation when the millimeter wave 45a was the vertically polarized wave TM and the horizontally polarized wave TE individually.

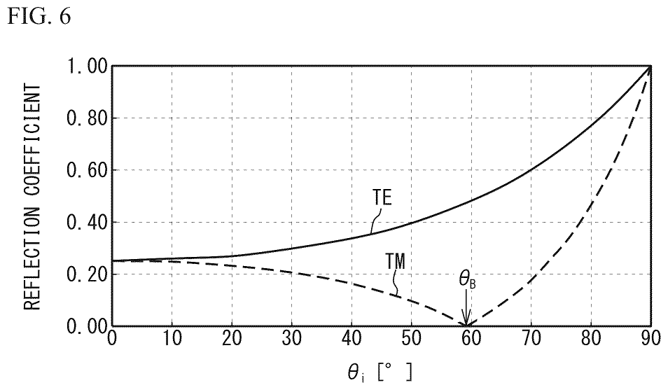

FIG. 6 is a graph illustrating reflection coefficients with respect to the incident angle θᵢ in the vertically polarized wave TM and the horizontally polarized wave TE. In FIG. 6, a horizontal axis represents the incident angle θᵢ, and a vertical axis represents the reflection coefficients when the vertically polarized wave TM and the horizontally polarized wave TE are incident into the dielectric layer 22 from the air.

As illustrated in FIG. 6, the reflection coefficient is about 0.25 when the incident angle θᵢ is 0° for both the horizontally polarized wave TE and the vertically polarized wave TM, and the reflection coefficient is 1 when the incident angle θᵢ is 90°. In the horizontally polarized wave TE, the reflection coefficient increases monotonously as the incident angle θᵢ increases. The reflection coefficient is about 0.48 when the incident angle θᵢ is 59°. In the vertically polarized wave TM, the reflection coefficient decreases as the incident angle θᵢ increases, and when the incident angle θᵢ, which is the Brewster angle θ_{B}, is 59°, the reflection coefficient becomes 0. When the incident angle θᵢ is larger than the Brewster angle θ_{B}, the reflection coefficient increases. In this way, when the incident angle θᵢ is the Brewster angle θ_{B}, the vertically polarized millimeter wave 45a is hardly reflected by the floor surface 21 and transmitted through the dielectric layer 22. In order to make the reflection coefficient 0.2 or less, the incident angle θᵢ is 30° to 70°. By setting the reflection coefficient to 0.2 or less, the variation of the power of the signal received by the reception unit 15 can be set to ±1 dB or less.

It is known that the attenuation coefficient α [dB/mm] of the high frequency signal in the dielectric layer is 27.3×√εᵣ×tan δ/λ [dB/mm]. Here, λ is a wavelength [mm] of the millimeter wave in vacuum. When the wavelength λ is expressed by the frequency f[Hz] of millimeter wave and the speed of light in vacuum c=3×10¹¹ [mm/s], it becomes an equation 7.

$$\\ \begin{matrix}α = 27.3 \times \sqrt{ε r} \times tan δ \times \frac{f}{c} & [ Equation 7 ]\end{matrix}$$

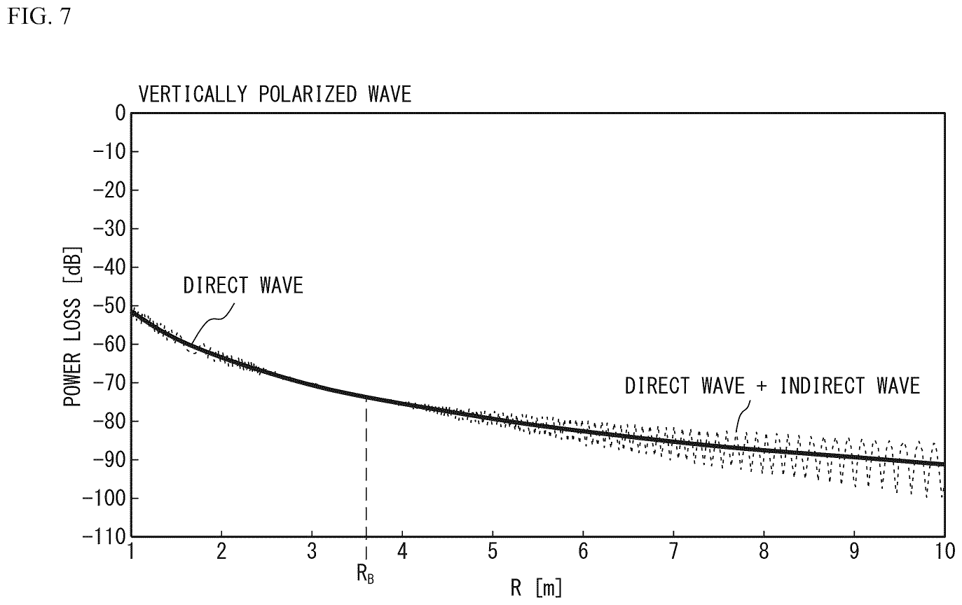

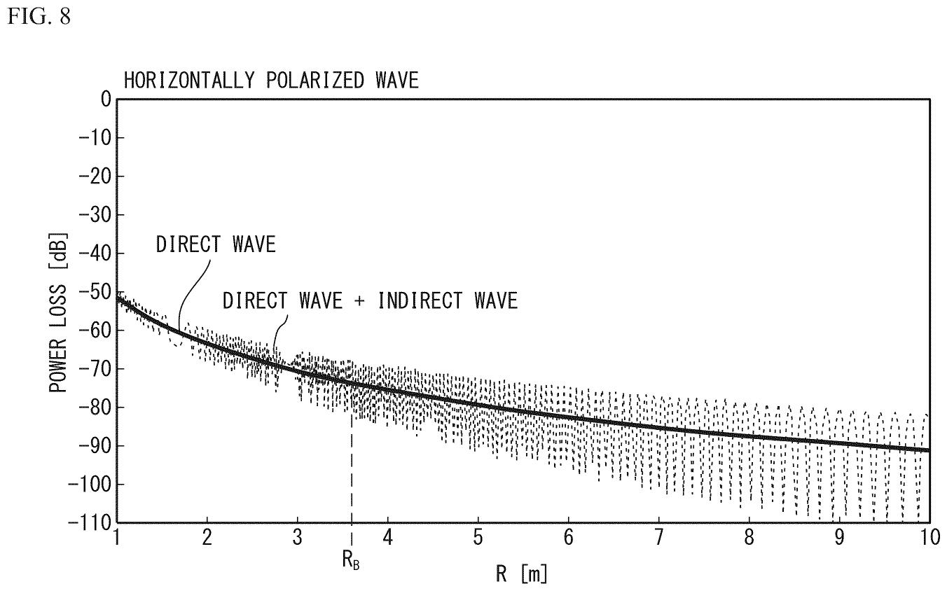

From the equation 7, it is found that the attenuation coefficient α of the Polypenco acetal having a relative dielectric constant of 2.8 and a tan δ of 0.02 is 0.24 dB/mm at 79 GHz. In FIG. 5A, when the incident angle θᵢ is 59°, which is the Brewster angle θ_{B}, the transmission angle θₜ is 31° according to the equation 5. When the thickness T1 of the dielectric layer 22 is 30 mm, the propagation length L of the millimeter waves 45b and 45c is about 70 mm according to the equation 6. The attenuation L×α of the millimeter wave in the dielectric layer 22 is about 17 dB. The power losses with respect to the distance R of the vertically polarized wave and the horizontally polarized wave under these conditions were calculated and illustrated in FIGS. 7 and 8.

FIG. 7 is a graph illustrating the power loss with respect to the distance R in the vertically polarized wave. The power loss of the direct wave is illustrated by a thick solid line, and the power loss of the direct wave and the indirect wave is illustrated by a broken line. As illustrated in FIG. 7, the variation of the direct wave and the indirect wave is smaller than that of the direct wave and the indirect wave of the comparative example illustrated in FIG. 4. In particular, when the distance R at which the incident angle θᵢ is the Brewster angle θ_{B} is R_{B}=3.6 m, the influence of the indirect wave is almost eliminated. This is because when the incident angle θᵢ is the Brewster angle θ_{B}, the millimeter wave 45a is not reflected on the upper surface of the dielectric layer 22 but is incident on the dielectric layer 22, the power loss when the millimeter waves 45b and 45c pass through the dielectric layer 22 is 17 dB, and the power of the millimeter wave 45d emitted from the dielectric layer 22 is very small. In FIG. 7, the influence of indirect waves is reduced in the range of the distance R from 2.5 m to 4.1 m. This is because, in this range, θᵢ is 50° to 62°, and the reflection coefficient of the vertically polarized millimeter wave on the floor surface 21 is 0.1 or less from FIG. 6.

FIG. 8 is a diagram illustrating the power loss with respect to the distance R in the horizontally polarized wave. The power loss of the direct wave is illustrated by a thick solid line, and the power loss of the direct wave and the indirect wave is illustrated by a broken line. As illustrated in FIG. 8, the variation of the direct wave and the indirect wave is smaller than that of the direct wave and the indirect wave of the comparative example illustrated in FIG. 4, but larger than that of the vertically polarized wave illustrated in FIG. 7. In this way, the influence of the indirect wave cannot be suppressed in the case of the horizontally polarized wave.

According to the first embodiment, the antenna 12 transmits to the object 30 the millimeter wave that is vertically polarized with respect to the floor 20, and receives the millimeter wave reflected at the object 30. The dielectric layer 22 (first dielectric layer) is provided on an uppermost layer of the floor 20 in a region including the portion 36 where the millimeter wave is reflected in the path 42 of the indirect wave. Since the millimeter wave 45a is vertically polarized, it is not easily reflected on the upper surface of the dielectric layer 22 and is incident into the dielectric layer 22. The reflective surface 23 is provided under the dielectric layer 22 and reflects the millimeter wave 45b propagating through the dielectric layer 22. That is, the millimeter wave 45b propagating through the dielectric layer 22 is reflected under the dielectric layer 22. In a millimeter wave system having the distance R of 10 m or less, the millimeter wave 45b incident into the dielectric layer 22 and the millimeter wave 45c reflected by the reflective surface 23 are attenuated in the dielectric layer 22 and are emitted from the dielectric layer 22. Therefore, the influence of the indirect wave can be further suppressed.

The vertically polarized millimeter wave (electromagnetic wave) is a millimeter wave (electromagnetic wave) in which an electric field component perpendicular to the floor surface 21 is larger than an electric field component horizontal to the floor surface 21. In order to suppress the reflection of the millimeter wave at the portion 36, the vertical electric field component is preferably 1.5 times or more, more preferably 2 times or more, and still more preferably 2.5 times or more the horizontal electric field component.

The relative dielectric constant of the dielectric layer 22 will be examined. Table 1 illustrates the relative dielectric constant εᵣ, the Brewster angle θ_{B}, the propagation length L, and materials. The relative dielectric constant εᵣ is the relative dielectric constant of the dielectric layer 22. The Brewster angle θ_{B} is the Brewster angle θ_{B} of the interface (floor surface 21) between the air and the dielectric layer 22. In FIG. 5A, the propagation length L is a length of propagation of the millimeter waves 45b and 45c when the incident angle θᵢ of the millimeter wave 45a is the Brewster angle θ_{B} and the thickness T1 of the dielectric layer 22 is 30 mm. The material is an example of a material having the relative dielectric constant εᵣ at 79 GHz.

TABLE 1

| RELATIVE | | PROPAGA- | |
|---|---|---|---|
| DIELECTRIC | BREWSTER | TION | |
| CONSTANT | ANGLE θ_{B} | LENGTH L | EXAMPLE OF |
| ε r | [°] | [mm] | MATERIAL |
| 2 | 55 | 73.24 | WOOD |
| 3 | 60 | 69.28 | GYPSUM BOARD |
| 4 | 63.4 | 67.1 | NYLON (FIBER-BASED |
| | | | FLOORING MATERIAL) |
| 5 | 65.9 | 65.72 | CONCRETE BOARD |
| 6 | 67.8 | 64.8 | GLASS |
| 7 | 69.3 | 64.14 | GLASS |
| 8 | 70.5 | 63.64 | MARBLE |
| 15 | 75.6 | 61.94 | MODERATELY DRY |
| | | | GROUND |
| 30 | 79.7 | 60.98 | WET GROUND |
| 81 | 83.7 | 60.36 | WATER |

As illustrated in Table 1, when the relative dielectric constant εᵣ increases, the Brewster angle θ_{B} increases and the propagation length L decreases. When the Brewster angle θ_{B} is large, if the incident angle θᵢ is made to be the Brewster angle θ_{B}, the distance R between the antenna 12 and the object 30 becomes longer when h1+h2 is constant from the Equation 1. As the distance R increases, the power loss of the reception power with respect to the transmission power increases as illustrated in FIG. 7, and the detection accuracy decreases. On the other hand, when the Brewster angle θ_{B} is small, if the incident angle θᵢ is made to be the Brewster angle θ_{B}, the distance R becomes shorter when h1+h2 is constant from the Equation 1. When the distance R becomes shorter, the range in which the object 30 can be detected becomes narrow. In consideration of these factors, the Brewster angle θ_{B} is preferably 55° to 68°. By setting the Brewster angle θ_{B} to 55° or more, the distance R can be increased and the range in which the object 30 can be detected can be widened. By setting the Brewster angle θ_{B} to 68° or less, the distance R can be decreased and the detection accuracy can be improved. In order to realize this, the dielectric constant εᵣ of the dielectric layer 22 at the frequency of the millimeter wave is preferably 2 or more and 6 or less. The Brewster angle θ_{B} is more preferably 56° to 65° (in this case, the relative dielectric constant εᵣ is 2.2 to 5), and still more preferably 57° to 63° (in this case, the relative dielectric constant εᵣ is 2.4 to 4). The distance R is preferably 1 m or more, and more preferably 2 m or more. The distance R is preferably 8 m or less, more preferably 6 m or less.

Examples of the material having the relative dielectric constant εᵣ of 2 or more and 6 or less include wood, gypsum board, fiber-based flooring such as nylon, and concrete board. Glass and marble have too large relative dielectric constants. Ground and water also have too large relative dielectric constants. The material having the relative dielectric constant εᵣ of 2 or more and 6 or less can be used as a floor material. On the other hand, when a radio wave absorber is used as in Patent Document 3, the radio wave absorber is not suitable for the floor material on which a pedestrian or the like walks because the radio wave absorber is made of a soft material. Further, the use of a three dimensional structure of a triangular pyramid or a mountain shape as the radio wave absorber is not suitable for the floor material.

Next, the incident angle θᵢ to the dielectric layer 22 will be examined. As illustrated in FIG. 6, by setting the incident angle θᵢ at which the millimeter wave is incident on the dielectric layer 22 at the portion 36 to 30° or more and 70° or less, the reflection coefficient of the vertically polarized millimeter wave at the portion 36 can be set to 0.2 or less. Thus, most millimeter waves are incident into the dielectric layer 22 and attenuate therein. Therefore, the influence of the indirect wave can be suppressed. When the dielectric constant of the dielectric layer 22 is in the range of 2 to 6, the Brewster angle θ_{B} is 55° to 68°, and by setting the incident angle θᵢ to 30° or more and 70° or less, the reflection coefficient of the vertically polarized millimeter wave at the portion 36 can be reduced, as in FIG. 6. The incident angle θᵢ of the vertically polarized millimeter wave at the portion 36 is preferably 40° or more, and more preferably 50° or more. The incident angle θᵢ is more preferably 65° or less.

Next, the height h1 of the antenna 12, the height h2 of the object 30, and the distance R will be examined. From the equation 1, (h1+h2)/R=1.732 is satisfied when the incident angle θᵢ is 30°, and (h1+h2)/R=0.364 is satisfied when the incident angle θᵢ is 70°. Therefore, it is preferable that 0.36≤(h1+h2)/R≤1.73 is satisfied. In the case where the object 30 is the dangerous object or dangerous material body held by the person or the chest of the person, h1+h2 is about 1 m to 3 m. In the case of the incident angle θᵢ=30°, the distance R is 0.58 m to 1.73 m when h1+h2 is 1 m to 3 m, and in the case of the incident angle θᵢ=70°, the distance R is 2.75 m to 8.24 m when h1+h2 is 1 m to 3 m. Thus, 0.68 m≤R≤8.24 m is satisfied. Similarly, in the case of θᵢ=40°, (h1+h2)/R=1.192 is satisfied, and when h1+h2 is 1 m to 3 m, the distance R is 0.84 m to 2.52 m. In the case of θᵢ=50°, (h1+h2)/R=0.839 is satisfied, and when h1+h2 is 1 m to 3 m, the distance R is 1.19 m to 3.58 m. In the case of θᵢ=60°, (h1+h2)/R=0.577 is satisfied, and when h1+h2 is 1 m to 3 m, the distance R is 1.73 m to 5.20 m.

Next, the thickness T1 and the dielectric loss tangent tan δ of the dielectric layer 22 will be examined. The thickness T1 and the dielectric loss tangent tan δ of the dielectric layer 22 are set so that the attenuation of the millimeter wave passing through the propagation length L is sufficient. The attenuation of the millimeter wave passing through the propagation length L is L×α. In the range of the relative dielectric constant of 2 to 6 and the incident angle θᵢ of 30° to 70°, the propagation length L is minimum when θᵢ=30° and εᵣ=6 are satisfied from the equations 5 and 6, and the propagation length L is 2.1×T1. The propagation length L is maximum when θᵢ=70° and εᵣ=2 are satisfied, and the propagation length L is 2.7×T1. In order to make L×α equal to or greater than 5 dB, assuming that L=2.1×T1 where the propagation length L is minimum, it is sufficient that 5≤2.1×T1×27.3×√εᵣ×tan δ×f/c is satisfied from the equation 7. The numerical values may be summarized as follows: 0.087≤T1×√εᵣ×tan δ×f/c. In order for L×α to be 10 dB or more, it is sufficient that 0.174≤T1×√εᵣ×tan δ×f/c is satisfied. In order for L×α to be 15 dB or more, it is sufficient that 0.262≤T1×√εᵣ×tan δ×f/c is satisfied.

For example, when the attenuation L×α in the dielectric layer 22 is 5 dB or more, the power of the millimeter wave 45d reflected by the floor surface 21 is attenuated by about 70% with respect to the power of the millimeter wave 45a. Therefore, the reception power does not become a blind spot at a frequency where the powers of the direct wave and the indirect wave cancel each other. When L×α is 10 dB or more, the power of the millimeter wave 45d is attenuated by about 90% with respect to the power of the millimeter wave 45a. Therefore, the low reception power level is eliminated at the frequency where the powers of the direct wave and the indirect wave cancel each other, and the reception power level and the like are not locally saturated at the frequency where the powers of the direct wave and the indirect wave increase each other. When L×α is 15 dB or more, the power of the millimeter wave 45d is attenuated by about 97% with respect to the power of the millimeter wave 45a. Therefore, the influence of the indirect wave on the reception power level can be almost ignored.

When the thickness T1 of the dielectric layer 22 is too small, the dielectric layer 22 is worn. From this viewpoint, the thickness T1 is preferably 5 mm or more, and more preferably 10 mm or more. When the thickness T1 of the dielectric layer 22 is too large, it is difficult to use the dielectric layer 22 as the floor material. From this viewpoint, the thickness T1 is preferably 100 mm or less, and more preferably 50 mm or less. In order to increase the attenuation of the millimeter waves 45b and 45c, the dielectric loss tangent tan δ of the dielectric layer 22 at the frequency f of the millimeter waves is preferably 0.005 or more, and more preferably 0.01 or more. The material having the large dielectric loss tangent tan δ tends to have the large relative dielectric constant. Therefore, the dielectric loss tangent tan δ of the dielectric layer 22 at the frequency f of the millimeter wave is 0.1 or less, or is 0.05 or less.

The frequency of the millimeter wave is 30 GHz or more and 300 GHz or less, but the above model is of the millimeter wave with the frequency of 79 GHz. Therefore, in order to generalize the above model, the frequency of the millimeter wave is preferably 50 GHz or more and 100 GHz or less, and more preferably 60 GHz or more and 90 GHz or less.

By limiting the thickness T1 of the dielectric layer 22, the tan δ of the dielectric layer 22, the frequency of the millimeter wave, and the like to the values described above, when the attenuation L×α of the millimeter wave by the dielectric layer 22 is 5 dB or more, it is possible to eliminate the blind spot at the frequency where the electric power of the direct wave and the indirect wave cancel each other as described above. When the attenuation L×α of the millimeter wave is 10 dB or more, it is possible to eliminate the low reception power level at the frequency where the power of the direct wave and the indirect wave cancel each other, and to suppress the local saturation of the reception power level or the like at the frequency where the powers of the direct wave and the indirect wave increase each other. This makes it possible to stably use a tracking function of the reception power level in the millimeter wave system. Furthermore, when the attenuation L×α of the millimeter wave is 15 dB or more, the influence of the indirect wave on the reception power level can be almost ignored. Thus, a prediction of the attenuation value can be made. In addition, when array antennas are used as the receiving antennas, the difference in the reception power level between the antennas is eliminated.

Although the millimeter wave system 100 has been described as an example of the millimeter wave system for the person or the material body held by the person, the millimeter wave system may be a system that detects an object at a relatively short distance. In the case where the object 30 is the person or the material body held by the person, h1+h2 is 1 m to 3 m, and the model of the first embodiment can be applied. In addition, when the portion 36 is located in a passage through which the person passes, it is difficult to provide the soft radio wave absorber and the radio wave absorber having the three dimensional structure of the triangular pyramid or the mountain shape on the floor. Therefore, it is preferable to provide the dielectric layer 22.

### Second Embodiment

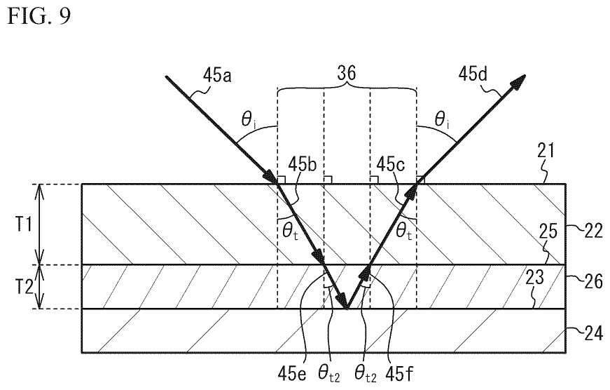

FIG. 9 is an enlarged cross-sectional view of the vicinity of the floor surface in a second embodiment. As illustrated in FIG. 9, in the region including the portion 36, the floor 20 is provided with a dielectric layer 26 having a thickness of T2 on the reflective layer 24 and the dielectric layer 22 having the thickness of T1 on the dielectric layer 26. An interface between the reflective layer 24 and the dielectric layer 26 is the reflective surface 23. An interface between dielectric layers 22 and 26 is an interface 25. The relative dielectric constant and the refractive index of the dielectric layer 26 are larger than those of the dielectric layer 22, respectively.

The millimeter wave 45a propagating through the space is incident on the floor surface 21 from the air at the incident angle θᵢ. The millimeter wave 45a is refracted at the floor surface 21 and transmitted to the dielectric layer 22 at the transmission angle θₜ. The millimeter wave 45b transmitted into the dielectric layer 22 is refracted at the interface 25 and transmitted to the dielectric layer 26 at a transmission angle θ₁₂. When the relative dielectric constant of the dielectric layer 26 at the frequency of the millimeter wave is made larger than the relative dielectric constant of the dielectric layer 22 at the frequency of the millimeter wave, the angle θₜ can be brought close to the Brewster angle at the interface 25. For example, when the relative dielectric constant of the dielectric layer 26 is about twice as large as the relative dielectric constant of the dielectric layer 22, θₜ is substantially equal to the Brewster angle at the interface 25. This can reduce the reflection of the millimeter wave 45b at the interface 25. At this time, the transmission angle θ₁₂ is smaller than the transmission angle θₜ. A millimeter wave 45e transmitted through the dielectric layer 26 is reflected by the reflective surface 23. A millimeter wave 45f reflected by the reflective surface 23 is refracted at the interface 25 and transmitted through the dielectric layer 22. The millimeter wave 45c incident into the dielectric layer 22 is refracted at the floor surface 21, and is emitted to the air as the millimeter wave 45d.

When the dielectric layer 22 is made of Polypenco acetal having the relative dielectric constant of 2.8 and the tan δ of 0.02 as in the first embodiment, and the dielectric layer 26 is made of Bakelite having the relative dielectric constant of 5.5 and the tan δ of 0.06, the attenuation coefficient α of the millimeter waves 45e and 45f having the frequency of 79 GHz is 0.7 dB/mm. Therefore, even if the thickness T1+T2 is smaller than the thickness T1 of the first embodiment, the attenuation of the millimeter wave can be further increased.

As in the second embodiment, the dielectric layer 26 (second dielectric layer) is provided between the dielectric layer 22 and the reflective surface 23, and the relative dielectric constant of the dielectric layer 26 at the frequency of the millimeter wave is made larger than the relative dielectric constant of the dielectric layer 22 at the frequency of the millimeter wave. This attenuates the millimeter waves 45e and 45f also in the dielectric layer 22. Therefore, the influence of the indirect wave can be further suppressed. The relative dielectric constant of the dielectric layer 26 at the frequency of the millimeter wave is preferably 1.2 times or more, and more preferably 2 times or more, the relative dielectric constant of the dielectric layer 22 at the frequency of the millimeter wave. The relative dielectric constant of the dielectric layer 26 at the frequency of the millimeter wave is preferably 3 times or less, and more preferably 2.5 times or less, the relative dielectric constant of the dielectric layer 22 at the frequency of the millimeter wave.

The dielectric loss tangent of the dielectric layer 26 at the millimeter wave frequency is greater than the dielectric loss tangent of the dielectric layer 22 at the millimeter wave frequency. In this case, the attenuation of the millimeter waves 45e and 45f in the dielectric layer 22 can be further increased. Therefore, the influence of the indirect wave can be further suppressed. The dielectric loss tangent of the dielectric layer 26 at the frequency of the millimeter wave is preferably 1.5 times or more, more preferably 2 times or more, the dielectric loss tangent of the dielectric layer 22 at the frequency of the millimeter wave.

In the first and second embodiments, the millimeter wave is described as an example of the high frequency electromagnetic wave, but the high frequency electromagnetic wave may be a microwave (having a frequency of 300 MHz to 30 GHz) or an electromagnetic wave having a frequency higher than the millimeter wave. For example, the frequency of the high frequency electromagnetic wave is 300 MHz to 1 THz. In addition, even under conditions outside the numerical ranges described in the first and the second embodiments, some of the effects of the first and the second embodiments may be obtained. The effectiveness of the first and the second embodiments is also recognized in a region outside these numerical ranges.

Although the embodiment of the present invention has been described in detail above, the present invention is not limited to the specific embodiment, and various modifications and changes can be made within the scope of the gist of the present invention described in the claims.

What is claimed is:

1. A high frequency system comprising:
an antenna that transmits a high frequency electromagnetic wave vertically polarized with respect to a floor to an object and receives the electromagnetic wave reflected by the object; and
a first dielectric layer provided on an uppermost layer of the floor in a region including a portion where the electromagnetic wave is reflected in a path of the electromagnetic wave between the antenna and the object, the first dielectric layer having a relative dielectric constant of 2 or more and 6 or less at a frequency of the electromagnetic wave;
wherein the electromagnetic wave propagating through the first dielectric layer is reflected under the first dielectric layer, and
a distance between the antenna and the object in a direction parallel to a plane including an upper surface of the first dielectric layer at the portion is 10 m or less.

2. The high frequency system according to claim 1, wherein
the electromagnetic wave is a millimeter wave.

3. The high frequency system according to claim 2, wherein
an incident angle of the electromagnetic wave incident on the first dielectric layer at the portion is 30° or more and 70° or less.

4. The high frequency system according to claim 2, wherein
0.35≤(h1+h2)/R≤1.73 is satisfied, where h1 is a distance between the antenna and a plane including an upper surface of the first dielectric layer at the portion, h2 is a distance between the plane and the object, and R is a distance between the antenna and the object in a direction parallel to the plane.

5. The high frequency system according to claim 3, wherein
0.087≤T1×√εᵣ×tan δ×f/c is satisfied, where T1 [mm] is a thickness of the first dielectric layer, εᵣ is a relative dielectric constant of the first dielectric layer at the frequency of the electromagnetic wave, tan δ is a dielectric loss tangent of the first dielectric layer at the frequency of the electromagnetic wave, f[Hz] is a frequency of the electromagnetic wave, and c [mm/s] is a speed of light in vacuum.

6. The high frequency system according to claim 3, wherein
the frequency of the electromagnetic wave is 60 GHz or more and 90 GHz or less.

7. The high frequency system according to claim 3, wherein
the frequency of the electromagnetic wave is 60 GHz or more and 90 GHz or less, and
0.087≤T1×√εᵣ×tan δ×f/c is satisfied, where T1 [mm] is a thickness of the first dielectric layer, εᵣ is a relative dielectric constant of the first dielectric layer at the frequency of the electromagnetic wave, tan δ is a dielectric loss tangent of the first dielectric layer at the frequency of the electromagnetic wave, f[Hz] is a frequency of the electromagnetic wave, and c [mm/s] is a speed of light in vacuum.

8. The high frequency system according to claim 1, further comprising:
a second dielectric layer provided between the first dielectric layer and a surface under the first dielectric layer, on which the electromagnetic wave propagating through the first dielectric layer is reflected, the second dielectric layer having a relative dielectric constant at the frequency of the electromagnetic wave higher than the relative dielectric constant of the first dielectric layer at the frequency of the electromagnetic wave.

9. The high frequency system according to claim 8, wherein
a dielectric loss tangent of the second dielectric layer at the frequency of the electromagnetic wave is greater than a dielectric loss tangent of the first dielectric layer at the frequency of the electromagnetic wave.

10. The high frequency system according to claim 2, wherein
the object is a person or a material body held by a person.
